(19) United States
(12) Patent Application Publication
(10) Pub. No.: US 2009/0281771 A1
(43) Pub. Date: Nov. 12, 2009

(54) TESTING SYSTEM FOR MOBILE PHONES AND TESTING METHOD THEREOF

(75) Inventors: QING-HUA LIU, Shenzhen City (CN); DAN-FENG WU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/170,154

(22) Filed: Jul. 9, 2008

(30) Foreign Application Priority Data
May 8, 2008 (CN) 200810301471.0

(51) Int. Cl. G06F 15/00; G06F 11/00

(52) U.S. Cl. 702/189; 702/188

(57) ABSTRACT

A testing system for mobile phones includes at least one workstation (112), at least one computer (110) connected to each workstation and a central server (100) connected to each computer. Each workstation is capable of interfacing with a to-be-tested mobile phone. Each computer includes a testing data collection module and a testing data uploading module. The testing data collection module is capable of collecting the testing data from the to-be-tested mobile phone. The testing data uploading module is capable of uploading the testing data to the central server. The central server is capable of receiving the testing data and analyzing the testing data.

### BACKGROUND

1. Technical Field

The present invention relates to a testing system for mobile phones and testing method thereof, specifically to an automatic testing system for mobile phones.

2. Description of Related Art

Mobile phones are becoming increasingly popular, and new models with enhanced functionality are constantly in demand. To ensure that a mobile phone is functioning as expected requires a series of tests before being put in use. Moreover, in a laboratory, a mobile phone is often subject to functional tests performed by R&D engineers for validating the performance thereof.

A functional test line of mobile phones has many workstations, each of which has one test for a component or a functional item. In a conventional testing procedure, only test results are manually recorded. On the other hand, medial test data, such as code from a failed product or an overall time of the testing process, or relative test information, such as the test time or the tester, have always been ignored. This test data, however, can sometimes provide useful information for analyzing the reason for product failure.

In the above-mentioned testing procedures, the testing process, which includes recording the testing results, are performed manually. Therefore, the testing procedures of mobile phones are time-consuming and error-prone.

### BRIEF DESCRIPTION OF THE DRAWINGS

FIG. 1 is a block view of a testing system for mobile phones in the present invention; and

FIG. 2 is a flowchart of a testing method for mobile phones in the present invention.

### DETAILED DESCRIPTION OF THE EMBODIMENT

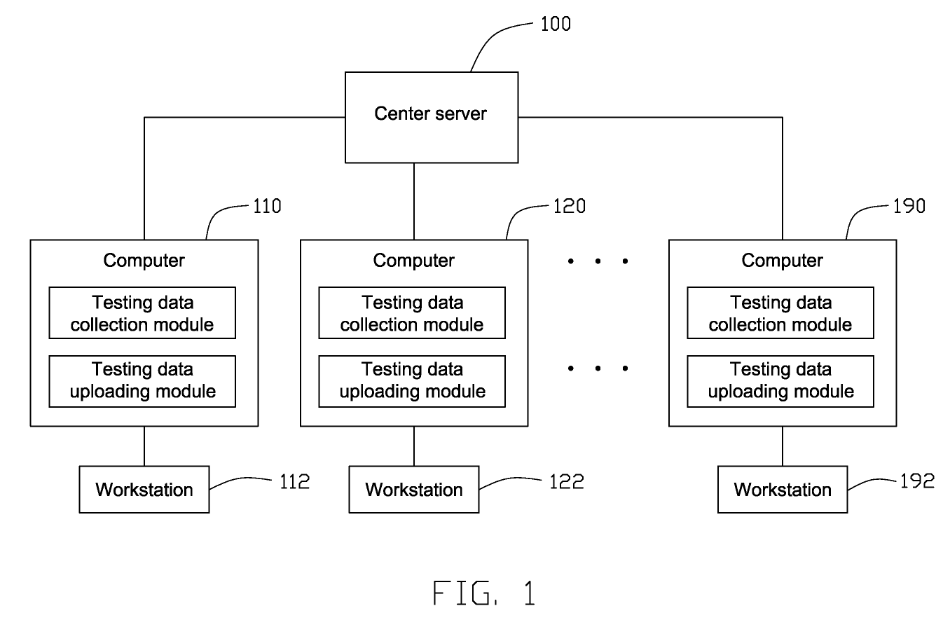

Referring to FIG. 1, a block view of a testing system for mobile phones is shown. The testing system for testing a plurality of to-be-tested mobile phones includes a central server 100, a plurality of computers 110, 120, 190 connected to the central server 100, and a plurality of workstations 112, 122, 192 connected to the computers 110, 120, 190, respectively. The workstations 112, 122, 192 are used for storing the to-be-tested mobile phones and executing the functional testing procedures. Each workstation 112/122/192 has one functional test, such as a key-press test, keyboard light indication test, ringing test, or wireless communication test, among other tests. The workstations 112, 122, 192 may have fixtures, series number (SN) scanning gun, or other instruments as needed.

Each to-be-tested mobile phone has an operating system (OS) embedded in its clip. A testing program for the functional test of the to-be-tested mobile phone is also written into the chip in advance. Each to-be-tested mobile phone has at least one series interface to communicate to the corresponding computer 110/120/190.

Each computer 110/120/190 has a testing data collection module and a testing data uploading module. The testing data collection module is used for collecting testing data from the to-be-tested mobile phone and adjusting the testing data to fit a uniform format. The testing data includes an SN, the name of the workstation, the testing item and the result. The SN is an identification of the testing data. The testing data uploading module is used for uploading the testing data with uniform format to the central server 100.

The central server 100 is capable of receiving the testing data with uniform format and analyzing the testing data thereof. Alternatively, the central server 100 may copy email or otherwise submit the testing data and the analyzed result of the testing data to the relative tester or anyone else.

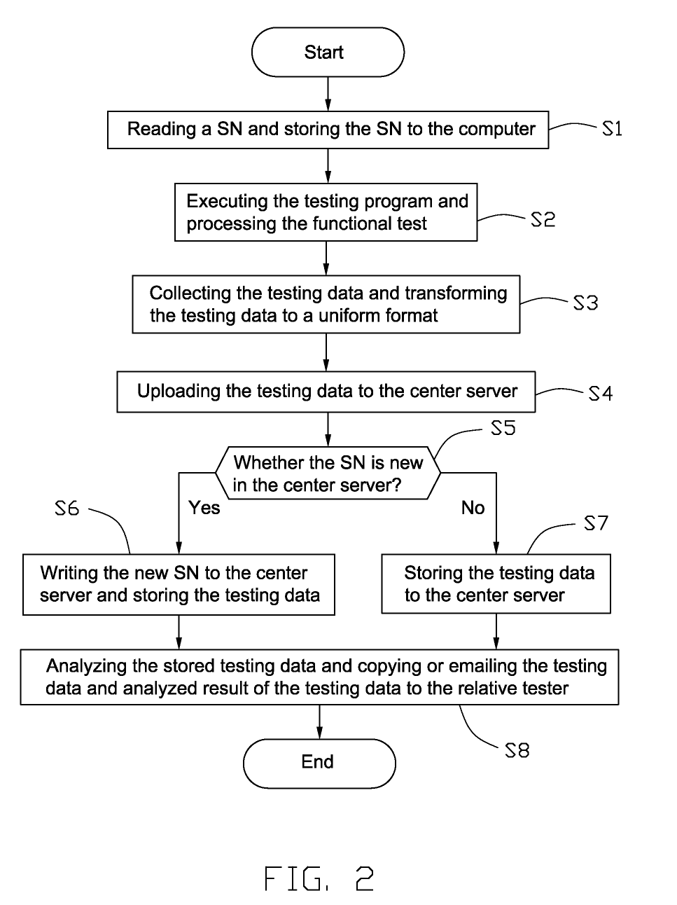

Referring to FIG. 2, a testing method includes the following steps.
Step S1: the computer 110/120/190 reads an SN from a to-be-tested mobile phone and stores the SN to the computer as testing data, the SN can be acquired by the scanning gun;
Step S2: executing the testing program and processing the functional test to the to-be-tested mobile phone;
Step S3: the computer 110/120/190 collects the testing data and transforms the testing data to fit a uniform format;
Step S4: the computer 110/120/190 uploads the testing data with the uniform format to the central server 100;
Step S5: the central server 100 receives the testing data and judges whether the SN of the testing data is new in the central server 100, if the SN is new, step S6 is executed, and if the SN already exists, step S7 is executed;
Step S6: writing the new SN to the central server 100 and storing the testing data to the central server 100 as identified by the new SN, then step S8 is executed;
Step S7: storing the testing data to the central server 100 as identified by the original SN, then step S8 is executed;
Step S8: the central server 100 analyzes the stored testing data, and alternatively copies or emails the testing data and the analyzed results of the testing data to the relative tester.

The testing system for mobile phones and the testing method thereof have the following advantages: first, all the tests results are processed automatically without human intervention, thereby saving testing time; second, the results are less error-prone since everything is automated, thereby enhancing the reliability of the test system; third, all the testing data is stored to one central server under uniform management, which is helpful in analyzing the testing data to determine the reasons behind product failure.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A testing system for mobile phones comprising:
at least one workstation capable of interfacing with a to-be-tested mobile phone;
at least one computer connected to the at least one workstation, each computer comprising a testing data collection module and a testing data uploading module, the testing data collection module being capable of collecting the testing data from the to-be-tested mobile phone; and
a central server connected to the at least one computer, wherein the testing data uploading module is capable of uploading the testing data to the central server, and the central server is capable of receiving the testing data and analyzing the testing data.

2. The testing system as claimed in claim 1, wherein the testing data received by the at least one computer comprises an SN, a name of the corresponding workstation, a testing item and a result.

3. The testing system as claimed in claim 1, wherein the testing data collection module is capable of transforming the testing data to a uniform format.

4. The testing system as claimed in claim 1, wherein the central server is capable of copying and emailing the testing data and the result.

5. The testing system as claimed in claim 1, wherein the functional test comprises a key-press test, a keyboard light test, a ringing test, a wireless communication test or any combination thereof.

6. A testing method for mobile phones comprising the following steps:
reading an identification from a to-be-tested mobile phone in a workstation;
executing a functional test;
collecting testing data from the mobile phone;
uploading the testing data comprising the identification to a central server;
receiving the testing data;
comparing the identification with previously stored data to determine if the identification is new; and
if the identification is new, writing the new identification to the central server, and storing the testing data to the central server as identified by the new identification,
if the identification is not new, storing the testing data to the central server as identified by the identification.

7. The method as claimed in claim 6, further comprising the step of: analyzing the testing data by the central server to achieve a result.

8. The method as claimed in claim 7, further comprising the step of: copying and emailing the testing data, the result or both.

9. The method as claimed in claim 6, wherein the functional test comprises key-press test, indicate light of keyboard test, ringing test, wireless communication test or any combination thereof.

10. The method as claimed in claim 6, wherein reading is done by a scanner.

11. The method as claimed in claim 6, wherein the testing data received by the computer comprises the identification, a name of the corresponding workstation, a testing item, a result or any combination thereof.

12. The method as claimed in claim 6, further comprising the step of: transforming the testing data to a uniform format.
